(19) United States
(12) Patent Application Publication
(10) Pub. No.: US 2011/0192317 A1
(43) Pub. Date: Aug. 11, 2011

(54) INK COMPOSITION FOR INK JET RECORDING

(75) Inventor: Shuichi Koganehira, Matsumoto-shi (JP)

(73) Assignee: Seiko Epson Corporation, Tokyo (JP)

(21) Appl. No.: 13/020,858

(22) Filed: Feb. 4, 2011

(30) Foreign Application Priority Data
Feb. 5, 2010 (JP) 2010-024765
Mar. 30, 2010 (JP) 2010-078945

(51) Int. Cl. C09D 11/02

(52) U.S. Cl. 106/31.9; 106/31.13; 524/386

(57) ABSTRACT

An ink composition for ink jet recording includes a colorant; water; a poor water-soluble alkanediol; a crystalline sugar alcohol that is solid at 20° C.; and one or two selected from the group consisting of polyalkylene glycols and water-soluble both-end-type alkanediols.

### BACKGROUND

1. Technical Field

The present invention relates to an ink composition for ink jet recording that can provide a high-quality and high-gloss recorded matter that is particularly excellent in graininess and inhibition of curling on various recording media, especially, even on recording media having a low ink-absorbing property, such as synthetic paper and printing paper.

2. Related Art

An ink jet recording method is a printing process for conducting printing by letting ink droplets fly and adhere to a recording medium such as paper. According to recent innovative progress in ink jet recording technology, the ink jet recording method has become to be also used in the field of highly fine printing that was achieved by silver halide photography or offset printing before. With the development of the ink jet recording method, inks for ink jet recording have been developed so that an image having gloss similar to that of silver halide photography can be formed by the ink jet recording on a recording medium, so-called exclusive paper, having high gloss comparable to that of photographic paper or art paper used in the fields of silver halide photography and offset printing. Furthermore, inks for ink jet recording that can realize image quality comparable to that of silver halide photography even when plain paper is used have been developed.

Incidentally, desk top publishing (DTP) has been spreading in recent years, in particular, in the printing field, with the wide spreading of a technology for forming an image from digital data. Even when printing is performed by DTP, a color proof is produced in advance for comparing the gloss and color impression with those of an actual printed matter. The ink jet recording system is applied to output of the proof, and exclusive paper for ink jet recording is usually used as the recording medium because of requirements for high color reproducibility and high color stability of the printed matter in DTP.

A proof sheet, which is exclusive paper for ink jet recording, is produced so as to provide gloss and color impression similar to those of actual output printed on printing paper. Thus, the material for the exclusive paper is appropriately adjusted according to the type of printing paper. On the other hand, production of exclusive paper that can correspond to all of various types of printing paper causes an increase in manufacturing cost. Accordingly, in the use for color proof, there is a demand for conducting ink jet recording on printing paper rather than on exclusive paper, from a technical viewpoint. Furthermore, if it is possible to use a recorded matter produced directly on printing paper, not on exclusive paper, by ink jet recording as a final proof sample, the cost for proof can be significantly decreased, and, therefore, such use is demanded from an economical viewpoint. In addition, synthetic paper, which is widely used in the printing field and is produced by mixing inorganic filler and the like with a polyethylene resin or a polyester resin and then forming the mixture into a film, has recently attracted attention as a material that is excellent in recyclability and environment-friendly. There is a demand for conducting recording on such synthetic paper from the environmental viewpoint.

The printing paper is coated paper having a surface provided with a coating layer for receiving oil-based ink and has a characteristic due to the coating layer being poor in aqueous-ink-absorbing ability. Therefore, if an aqueous pigment ink, which is usually used in ink jet recording, is used, bleeding or aggregation spots may occur in an image because of low permeability of the ink into the recording medium (printing paper).

For the above-mentioned problems, for example, JP-A-2005-194500 discloses a pigment ink that is improved in bleeding and is excellent in gloss on exclusive paper by using a polysiloxane compound as a surfactant and including an alkanediol, such as 1,2-hexanediol, as a solubilization aid. In addition, JP-A-2003-213179, JP-A-2003-253167, and JP-A-2006-249429 propose to obtain a high-quality image by controlling permeability of ink into a recording medium by adding a diol solvent, such as glycerin or 1,3-butanediol, or a triol solvent, such as pentanetriol, to the ink.

Furthermore, JP-A-2009-286998 and JP-A-2009-269964 propose ink compositions that can achieve formation of high-quality images and inhibit occurrence of curling.

### SUMMARY

The inventors have recently found the fact that when an ink composition for ink jet recording contains a poor water-soluble alkanediol and a crystalline sugar alcohol that is solid at 20° C. (hereinafter, may be simply referred to as “crystalline sugar alcohol”) and also contains one or two selected from the group consisting of polyalkylene glycols and water-soluble both-end-type alkanediols, a high-quality and high-gloss image free from bleeding and beading and, in particular, being excellent in inhibition of curling can be formed on a recording medium having a low aqueous-ink-absorbing property, such as printing paper, even when printing with a short difference in ink landing time is performed, and a recovery property from clogging is excellent even after being left under an open environment at high temperature and low humidity and under a close environment at high temperature and ordinary humidity. Furthermore, the inventors have found the fact that even when the concentration of a colorant is 3% by mass or less, these effects can be achieved, and excellent graininess can be obtained.

An advantage of some aspects of the invention is to provide a ink composition for ink jet recording that can form a high-quality and high-gloss image free from bleeding and beading and, in particular, being excellent in graininess and inhibition of curling even when printing with a short difference in ink landing time is performed on a recording medium having a low aqueous-ink-absorbing property, such as printing paper, and that is excellent in a recovery property from clogging even after being left under an open environment at high temperature and low humidity and under a close environment at high temperature and ordinary humidity.

The ink composition for ink jet recording according to an aspect of the invention contains a colorant, water, a poor water-soluble alkanediol, and a crystalline sugar alcohol that is solid at 20° C. and also contains one or two selected from the group consisting of polyalkylene glycols and water-soluble both-end-type alkanediols.

According to the ink composition for ink jet recording according to an aspect of the invention, it can be provided an ink composition that can form a high-quality and high-gloss image free from bleeding and beading and, in particular, being excellent in graininess and inhibition of curling even when printing with a short difference ink landing time is performed on a recording medium having a low aqueous-ink-absorbing property, such as printing paper, and that is excellent in a recovery property from clogging even after being left under an open environment at high temperature and low humidity and under a close environment at high temperature and ordinary humidity.

### DESCRIPTION OF EXEMPLARY EMBODIMENTS

### Definition

In the specification, the hydrocarbon group portion of an alkanediol may be either a linear chain or a branched chain.

The term “water-soluble” refers to that the solubility in water (the amount of a solute in 100 g of water) at 20° C. is 10.0 g or more, and the term “poor water-soluble” refers to that the solubility in water (the amount of a solute in 100 g of water) is less than 1.0 g. The term “miscible” refers to that a solution is translucent when the solubility in water (the amount of a solute in 100 g of water) at 20° C. is 10.0 g.

### Ink Composition

The ink composition according to an aspect of the invention contains a poor water-soluble alkanediol and a specific crystalline sugar alcohol and also contains one or two selected from the group consisting of polyalkylene glycols and water-soluble both-end-type alkanediols. By containing these organic solvents and other components in combination, for example, provided is an ink composition that is inhibited from beading in printing on printing paper; that can form a high-quality and high-gloss image free from bleeding and beading and, in particular, being excellent in graininess and inhibition of curling even when printing with a short difference in ink landing time is performed; that is excellent in a recovery property from clogging even after being left under an open environment at high temperature and low humidity and under a close environment at high temperature and ordinary humidity; and that is excellent in discharge stability.

In the specification, the term “beading” refers to local density spots with similar colors occurring in monochromatic printing (for example, when a 6-inch square monochromatic image (which means that a single color is obtained as a result of the printing, and a plurality of ink compositions may be used for forming the color) is printed) and does not refer to that a region not covered with the ink remains on a recording medium surface. Furthermore, the term “bleeding of a color material” refers to a phenomenon in that a mixed color occurs near the boundary between adjoining monochromatic images (for example, when 3-inch square monochromatic images having the respective colors are printed so as to adjoin to one another). The term “bleeding of a solvent” refers to a phenomenon in that density spots with similar colors occur near the boundary between adjoining monochromatic images (for example, when 3-inch square monochromatic images having the respective colors are printed so as to adjoin to one another) by a change in the coating state, which is caused by migration of the color material or the like by leaching of the solvent.

With regard to the graininess, when an ink composition containing small amounts of color materials showing different colors gives a smaller dot size of a landed ink droplet in printing, the ink composition is more excellent in graininess. An ink composition that gives a line having a narrower width and a smaller width difference between the narrowest and the widest provides a higher definition image.

In an aspect of the invention, when thin printing paper having a paper weight of 73.3 to 104.7 g/m² or 104.7 to 209.2 g/m² is used, furthermore, even when thin printing paper having a paper weight of 73.3 to 104.7 g/m² is used as the above-described recording medium, the printed face is inhibited from rolling inward, that is, so-called curling is inhibited from occurring.

As described above, it is not clear why a high-quality image free from bleeding and beading can be formed by an ink composition containing a poor water-soluble alkanediol, in addition to one or two selected from the group consisting of polyalkylene glycols and water-soluble both-end-type alkanediols and a crystalline sugar alcohol that is solid at 20° C., but it is assumed as follows.

The beading of an ink that occurs in recording on printing paper is thought to be caused by that the printing paper repels the ink because of the high surface tensions of ink droplets and large contact angles of the ink droplets with the printing paper surface. The repelled ink droplets flow together with adjacent ink droplets to aggregate with one another, resulting in beading. Therefore, it is believed that, in order to inhibit beading of ink, it is preferable to inhibit flowage spots of ink droplets by reducing the surface tension of the ink droplets.

The bleeding of ink that occurs in recording on printing paper is thought to be caused by that since the surface tensions of ink droplets are different, when the ink droplets adhere to a printing paper surface, ink droplets having low surface tensions saturate ink droplets having high surface tensions and spread thereto, resulting in a flow of the ink. This ink flow is thought to be also affected by the difference of adhesion times of adjacent ink droplets and the sizes of droplets at the time of adhering.

Therefore, it is believed that, in order to inhibit bleeding of ink, it is preferable to adjust the surface tensions of ink compositions to be equal. However, since it is difficult to, also, adjust the intervals of adhesion times of adjacent ink droplets to be constant and the sizes of droplets at the time of adhering to be equal, it is believed that it is preferable to reduce flowage spots of ink droplets.

It is believed that, in the ink composition according to an aspect of the invention, ink having a low surface tension and low fluidity can be achieved without impairing other qualities required in an ink composition, and, as a result, bleeding and beading are reliably inhibited.

### Poor Water-Soluble Alkanediol

The ink composition according to an aspect of the invention contains a poor water-soluble alkanediol.

According to a preferred aspect of the invention, the poor water-soluble alkanediol is a one-end-type alkanediol. In a preferred aspect of the invention, the poor water-soluble alkanediol is preferably an alkanediol having 7 or more carbon atoms, more preferably an alkanediol having 7 to 10 carbon atoms, and most preferably a poor water-soluble 1,2-alkanediol, which can more reliably inhibit beading. Examples of the poor water-soluble 1,2-alkanediol include 1,2-heptanediol, 1,2-octanediol, 5-methyl-1,2-hexanediol, 4-methyl-1,2-hexanediol, and 4,4-dimethyl-1,2-pentanediol. Most preferred is 1,2-octanediol.

According to a preferred aspect of the invention, the content of the poor water-soluble alkanediol may be appropriately determined in a range that can efficiently inhibit bleeding and beading of the ink, but is preferably 1.0 to 4.0% by mass, more preferably 1.5 to 3.0% by mass, and most preferably 2.0 to 2.5% by mass based on the total amount of the composition. An amount of the poor water-soluble alkanediol within the above-mentioned range, especially, an amount not less than the lower limit, can sufficiently inhibit occurrence of beading. In addition, an amount of the poor water-soluble alkanediol within the above-mentioned range, especially, an amount not higher than the upper limit, can prevent the initial viscosity of the ink from becoming too high and can effectively avoid separation of an oil phase under usual ink storage conditions, and is therefore preferred from the viewpoint of ink storage stability.

### Polyalkylene Glycol

The ink composition according to an aspect of the invention may contain a polyalkylene glycol. The ink composition according to an aspect of the invention contains one or two selected from the group consisting of polyalkylene glycols and water-soluble both-end-type alkanediols described below, but from the viewpoint that linkage between adjacent dots of landed droplets can be appropriately controlled according to the method of recording or the type of printing paper, the ink composition more preferably contains both a polyalkylene glycol and a water-soluble both-end-type alkanediol described below.

The polyalkylene glycol contained in the ink composition according to an aspect of the invention is preferably represented by a formula: HO—[(CH₂)ₙ—O)]ₘ—H (in the formula, n denotes 2 or 3, and m denotes an integer of 1 to 3), and is more preferably one or more selected from the group consisting of ethylene glycol, diethylene glycol, triethylene glycol, propylene glycol, dipropylene glycol, and tripropylene glycol. These compounds are oligomers obtained by additional polymerization of ethylene oxide and/or propylene oxide. According to a preferred aspect of the invention, the polyalkylene glycol is more preferably a polypropylene glycol and most preferably a water-miscible polypropylene glycol. The polypropylene glycol is not particularly limited, but is preferably a diol-type from the viewpoints of ecotoxicity and environmental toxicity, and is more preferably tripropylene glycol (CAS No. 24800-44-0) from the viewpoint of its low moisture absorbency. Most preferably, the diol-type polypropylene glycol and the tripropylene glycol are water-miscible.

In an aspect of the invention, the amount of the polyalkylene glycol may be appropriately determined in a range that can efficiently inhibit bleeding and beading of the ink, but is preferably 2.0 to 6.0% by mass and more preferably 3.0 to 5.0% by mass based on the total amount of the ink composition. An amount of the polyalkylene glycol within the above-mentioned range, especially, an amount not lower than the lower limit, can maintain the poor water-soluble alkanediol in a mixed state without causing separation in the drying process of ink droplets and is therefore preferred. An amount of the polyalkylene glycol within the above-mentioned range, especially, an amount not higher than the upper limit, can prevent the initial viscosity of the ink from becoming too high and can effectively avoid separation of an oil phase under usual ink storage conditions and is therefore preferred from the viewpoint of ink storage stability, and also such an amount can prevent occurrence of an incompatible state and is therefore preferred from the viewpoint of gloss.

In addition, the polyalkylene glycol contained in the ink composition according to an aspect of the invention is hardly dried even if it is left under high temperature and low humidity and can also advantageously improve the recovery property from clogging of a nozzle under an open environment of 50° C./15% humidity.

Furthermore, it has been found that the ink composition according to an aspect of the invention in which a pigment is dispersed in a dispersion resin shows an effect of inhibiting the ink from too rapidly aggregating on a recording medium. The reason thereof is not clear, but it is assumed as follows.

It is thought that, in general, at the moment when ink adheres to a recording medium, the lipophilic components in the ink are still being dispersed in water, but phase transition from an O/W state to a W/O state is caused by that the water is lost first during the drying process after the adhesion of the ink to the recording medium. The aqueous phase of the ink includes a pigment dispersed in a water-dispersible resin, but the pigment cannot be present in the oil phase. Therefore, it is thought that the fluidity of the pigment in the aqueous phase is prevented by the wall of the oil phase when the O/W state is phase-transited to the W/O state, which causes flowage spots, resulting in aggregation of the ink. However, it is thought that since the polyalkylene glycol allows water and a poor water-soluble solvent to mutually dissolve into each other and can maintain the mixed state for a long time, formation of the wall of the oil phase is prevented. It is thought that, as a result, the pigment can be held in the mixed phase to prevent flowage spots from being formed, resulting in inhibition of formation of infiltration spots of the ink.

### Water-Soluble Both-End-Type Alkanediol

The ink composition according to an aspect of the invention may contain a water-soluble both-end-type alkanediol. The ink composition according to an aspect of the invention contains one or two selected from the group consisting of the above-described polyalkylene glycols and water-soluble both-end-type alkanediols, but from the viewpoint that linkage between adjacent dots of landed droplets can be appropriately controlled according to the method of recording or the type of printing paper, the ink composition more preferably contains both a polyalkylene glycol and a water-soluble both-end-type alkanediol.

The water-soluble both-end-type alkanediol contained in the ink composition according to an aspect of the invention preferably has a branched chain and more preferably has six or less carbon atoms and more preferably contains one or more selected from the group consisting of 2-methyl-1,3-propanediol, 3-methyl-1,5-pentanediol, 1,5-pentanediol, and 1,6-hexanediol. From the viewpoints of ecotoxicity and environmental toxicity, 3-methyl-1,5-pentanediol is most preferred.

In an aspect of the invention, the amount of the water-soluble both-end-type alkanediol may be appropriately determined in a range that can efficiently inhibit bleeding and beading of the ink, but is preferably 2.0 to 6.0% by mass and more preferably 3.0 to 5.0% by mass based on the total amount of the ink composition. An amount of the water-soluble both-end-type alkanediol within the above-mentioned range, especially, an amount not lower than the lower limit, can maintain the poor water-soluble alkanediol in a mixed state without causing separation in the drying process of ink droplets and is therefore preferred. An amount of the water-soluble both-end-type alkanediol within the above-mentioned range, especially, an amount not higher than the upper limit, can prevent the initial viscosity of the ink from becoming too high and can effectively avoid separation of an oil phase under usual ink storage conditions and is therefore preferred from the viewpoint of ink storage stability, and also such an amount can prevent occurrence of an incompatible state and is therefore preferred from the viewpoint of gloss.

Since the water-soluble both-end-type alkanediol contained in the ink composition according to an aspect of the invention can reduce a phenomenon in that edges of ink droplets landed on printing paper having low ink absorbability spread along fiber orientation of the printing paper, the water-soluble both-end-type alkanediol also advantageously provides excellent reproducibility of fine ruled lines.

The content ratio of the poor water-soluble alkanediol and one or two selected from the group consisting of the polyalkylene glycols and the water-soluble both-end-type alkanediols is preferably 1:1 to 1:3 and more preferably 1:1 to 1:2. In this range, the discharge stability of ink can be improved.

The sum of the content of the poor water-soluble alkanediol and the content of one or two selected from the group consisting of the polyalkylene glycols and the water-soluble both-end-type alkanediols is preferably 16.0% by mass or less, more preferably 12.5% by mass or less, and most preferably 8.5% by mass based on the amount of the ink composition. In this range, the initial viscosity of ink can be lowered; occurrence of beading on a recording medium having low ink absorbability, such as printing paper, can be prevented; and the recovery property from clogging under an open environment at high temperature and low humidity can be suitably adjusted.

### Crystalline Sugar Alcohol

The ink composition according to an aspect of the invention contains a crystalline sugar alcohol that is solid at 20° C.

The crystalline sugar alcohol is not particularly limited as long as it can achieve the effects of the invention, but is preferably one or more selected from the group consisting of maltitol, sorbitol, xylitol, erythritol, trehalose, isotrehalose, neotrehalose, and sucrose, and more preferably one or more selected from the group consisting of trehalose, isotrehalose, neotrehalose, and sucrose. Furthermore, the crystalline sugar alcohol may be a tri- or higher saccharide in which one or more monosaccharides or disaccharides selected from the group consisting of maltitol, sorbitol, xylitol, erythritol, trehalose, isotrehalose, neotrehalose, and sucrose are bonded to each other or to another saccharide.

Trehalose is a nonreducing disaccharide in which 1-positions of two glucose molecules are linked to each other by a glucoside bond. Since trehalose is a nonreducing saccharide, brown discoloration by a Maillard reaction does not occur. Therefore, trehalose is preferred from the viewpoint of ink storage stability. In addition, since the crystallinity of trehalose is high, it has characteristics that water solubility is low and that moisture absorbency is significantly low.

Isotrehalose, neotrehalose, and sucrose are nonreducing disaccharides in which glycoside bonds are formed. Since they are nonreducing disaccharides, brown discoloration by a Maillard reaction does not occur. Therefore, they are preferred from the viewpoint of ink storage stability. In addition, since their crystallinity is high, they have characteristics that water solubility is low and that moisture absorbency is significantly low.

The ink composition containing such a crystalline sugar alcohol can inhibit beading, which is caused by flowage spots that occur, in particular, when printing with a short difference in ink landing time is performed. The reason thereof is not clear, but it is assumed that since the crystalline sugar alcohol is not dissolved in a solvent and has low water solubility and high crystallinity, solidification occurs immediately after ink landing to reduce fluidity of the ink, which inhibits formation of flowage spots and thereby inhibits occurrence of beading. In addition, it is assumed that since the fluidity is immediately inhibited, ink droplets coming into contact with already landed ink droplets are hardly affected by the already landed ink droplets, which inhibits formation of flowage spots and thereby inhibits occurrence of beading even in multicolor printing. Furthermore, it is assumed that the osmotic pressure is increased by the large amount of the water-soluble sugar, according to van't Hoff's law, to increase the permeation rate.

The ink composition containing such a crystalline sugar alcohol can have an improved recovery property from clogging under a close environment at high temperature and ordinary humidity. The reason thereof is not clear, but it is assumed that since the crystalline sugar alcohol has significantly low moisture absorbency, waste ink remaining in a cap does not seize moisture from the meniscus ink in a nozzle, resulting in an excellent recovery property from clogging in the state in which the cap is sealed.

Furthermore, since the ink composition containing such a crystalline sugar alcohol prevents ice crystals from growing, low-temperature storage stability of the ink can be improved.

According to a preferred aspect of the invention, the amount of the crystalline sugar alcohol may be appropriately determined in a range that the above-described effects can be achieved, but is preferably 12.0 to 24.0% by mass and more preferably 16.0 to 20.0% by mass based on the total amount of the ink composition. An amount of the crystalline sugar alcohol within the above-mentioned range, especially, an amount not lower than the lower limit, can improve the recovery property from clogging under a close environment at high temperature and ordinary humidity and is therefore preferred, and such an amount is also preferred from the viewpoint of gloss. An amount of the crystalline sugar alcohol within the above-mentioned range, especially, an amount not higher than the upper limit, prevents the initial viscosity of the ink from becoming too high and decreases the freezing temperature of the ink and is therefore preferred from the viewpoint of low-temperature storage stability of the ink. In addition, even when printing is performed on thin printing paper having a paper weight of 73.3 g/m² or less or on a PPC sheet (plain paper), the printed face is inhibited from rolling inward, that is, so-called curling is significantly inhibited from occurring. The reason thereof is not clear, but it is assumed as follows. Cellulose is a saccharide having a long chain in which monosaccharides are linked (polymerized). Curling is caused by that hydrogen bonds between cellulose molecules are cleaved by water molecules and that hydrogen bonds are reformed, when the water is evaporated and dried, between the cellulose molecules at positions differing from the positions where the hydrogen bonds were cleaved. Therefore, curling can be inhibited from occurring by blocking the reformation of the hydrogen bonds between cellulose molecules as quickly as possible after the evaporation and drying of water. An effective material as the inhibitor is a crystalline sugar alcohol having a molecular structure similar to that of cellulose and is preferably trehalose, isotrehalose, neotrehalose, and sucrose, which have excellent drying property and recrystallizing property.

Furthermore, according to a preferred aspect of the invention, the content ratio of the poor water-soluble alkanediol and the crystalline sugar alcohol is preferably 1:6 to 1:12 and more preferably 1:8 to 1:10. Within this range, beading when ink droplet landing intervals are short can be inhibited. In particular, when the color material concentration is 3% by mass or less, the effects can be certainly achieved.

The ratio of the total content of the crystalline sugar alcohol and one or two selected from the group consisting of the polyalkylene glycols and the water-soluble both-end-type alkanediols and the content of the poor water-soluble alkanediol is preferably 9:1 to 15:1. Within this range, recovery properties from clogging under an open environment at high temperature and low humidity and under a close environment at high temperature and ordinary humidity can be ensured. The reason thereof is not clear, but it is assumed to be caused by a well balance between the effect of one or two selected from the group consisting of the polyalkylene glycols and the water-soluble both-end-type alkanediols for redissolving solidified ink near a nozzle and the effect of the crystalline sugar alcohol for blocking absorption of moisture.

A recorded matter having excellent gloss can be obtained without causing beading, even when ink droplet landing intervals are short, by adjusting the content ratio within the above-mentioned range. The reason thereof is not clear, but it is assumed to be caused by a well balance between the effect of mixing and dissolving a poor water-soluble alkanediol by means of one or more selected from the group consisting of the polyalkylene glycols and the water-soluble both-end-type alkanediols and the effect of inhibiting flowage spots by increasing the amount of solid of the crystalline sugar alcohol.

The sum of the content of the poor water-soluble alkanediol and the content of the crystalline sugar alcohol is preferably 28.0% by mass or less and more preferably 26.0% by mass or less based on the amount of the ink composition. In this range, the initial viscosity of the ink can be lowered; and the recovery property from clogging under a close environment at high temperature and ordinary humidity can be appropriately adjusted without causing beading on a recording medium having low ink absorbability, such as printing paper.

Furthermore, according to a preferred aspect of the invention, the sum of the content of the poor water-soluble alkanediol, the content of one or more selected from the group consisting of the polyalkylene glycols and the water-soluble both-end-type alkanediols, and the content of the crystalline sugar alcohol is preferably 34% by mass or less based on the amount of the ink composition. In this range, the initial viscosity of ink can be lowered; and the recovery properties from clogging under an open environment at high temperature and low humidity and under a close environment at high temperature and ordinary humidity can be appropriately adjusted without causing beading on a recording medium having low ink absorbability, such as printing paper.

### Water-Soluble One-End-Type Alkanediol

According to a preferred aspect of the invention, the ink composition according to an aspect of the invention contains a poor water-soluble alkanediol, a crystalline sugar alcohol that is solid at 20° C., and one or more selected from the group consisting of polyalkylene glycols and water-soluble both-end-type alkanediols and may further contain a water-soluble one-end-type alkanediol. This can inhibit bleeding of materials other than the solids contained in the ink composition, that is, bleeding of the aqueous solution including the solvent can be advantageously inhibited.

The water-soluble one-end-type alkanediol according to an aspect of the invention is preferably an alkanediol having three or more carbon atoms and more preferably having three to six carbon atoms. 1,2-Hexanediol is a preferred example of the water-soluble one-end-type alkanediol contained in the ink composition according to an aspect of the invention.

Furthermore, according to a preferred aspect of the invention, the content ratio of the poor water-soluble alkanediol and the water-soluble one-end-type alkanediol is preferably 1:1 to 10:1 and more preferably 2:1 to 4:1. In this range, beading when ink droplet landing intervals are short can be inhibited.

According to a preferred aspect of the invention, the sum of the content of the water-soluble one-end-type alkanediol and the content of the crystalline sugar alcohol is preferably 28.0% by mass or less and more preferably 22.5% by mass or less based on the amount of the ink composition. In this range, beading when ink droplet landing intervals are short can be inhibited.

According to a preferred aspect of the invention, the sum of the content of the water-soluble one-end-type alkanediol and the content of one or more selected from the group consisting of the polyalkylene glycols and the water-soluble both-end-type alkanediols is preferably 16.0% by mass or less, more preferably 12.0% by mass or less, and most preferably 8.0% by mass or less based on the amount of the ink composition. In this range, bleeding when ink droplet landing intervals are short can be inhibited.

The sum of the content of one or two selected from the group consisting of the polyalkylene glycols and the water-soluble both-end-type alkanediols, the content of the water-soluble one-end-type alkanediol, and the content of the poor water-soluble alkanediol is preferably 20.0% by mass or less, more preferably 14.5% by mass or less, and most preferably 10.5% by mass or less based on the amount of the ink composition. In this range, bleeding when ink droplet landing intervals are short can be inhibited.

The sum of the content of the crystalline sugar alcohol, the content of the water-soluble one-end-type alkanediol, and the content of the poor water-soluble alkanediol is preferably 32.0% by mass or less and more preferably 28.5% by mass or less based on the amount of the ink composition. In this range, bleeding when ink droplet landing intervals are short can be inhibited.

According to a preferred aspect of the invention, the amount of the water-soluble one-end-type alkanediol may be appropriately determined as long as it can efficiently inhibit bleeding and beading of the ink, but is preferably 0.1 to 4.0% by mass, more preferably 0.5 to 3.0% by mass, and most preferably 1.0 to 2.0% by mass based on the total amount of the ink composition. An amount of the water-soluble one-end-type alkanediol in the above-mentioned range, especially, an amount not lower than the lower limit, can sufficiently inhibit occurrence of bleeding. An amount of the water-soluble one-end-type alkanediol in the above-mentioned range, especially, an amount not higher than the upper limit, can prevent the initial viscosity of the ink from becoming too high and can effectively avoid separation of an oil phase under usual ink storage conditions, and is therefore preferred from the viewpoint of ink storage stability. When 1,2-hexanediol is contained as a preferred example of the water-soluble one-end-type alkanediol in an amount of 0.1 to 4.0% by mass based on the total amount of the ink composition, a high-quality image free from bleeding and beading can be achieved. Thus, 1,2-hexanediol is effective as an adjuster when a discharging ability varies depending on the type of the pigment and the amount of the resin.

### Other Solvent

According to a preferred aspect of the invention, the ink composition may further contain triethylene glycol monomethyl ether. By containing 0.1 to 4% by mass of triethylene glycol monomethyl ether, the recovery property from clogging in the ink cap for capping an ink jet head can be improved. Here, the term “clogging in the ink cap” refers to that liquid waste remaining in the cap is solidified by drying and clogs the micropores of an ink absorber, such as nonwoven fabric, in the ink cap. By improving the recovery property from clogging in the ink cap, a reduction in success rate of cleaning can be prevented, and the recovery property from nozzle clogging can be improved.

### Colorant

The colorant used in the ink composition for ink jet recording according to an aspect of the invention may be a dye or a pigment, but the pigment is preferred from the viewpoints of light resistance and water resistance. Furthermore, the colorant preferably contains the pigment and a dispersant, described below, that can disperse the pigment in ink.

Examples of the pigment include inorganic pigments and organic pigments, and these may be used alone or as a mixture of two or more thereof. Examples of the organic pigment include azo pigments (including, for example, azolakes, insoluble azo pigments, condensed azo pigments, and chelate azo pigments), polycyclic pigments (for example, phthalocyanine pigments, perylene pigments, perynone pigments, anthraquinone pigments, quinacridone pigments, dioxadine pigments, thioindigo pigments, isoindolinone pigments, and quinophthalone pigments), dye chelates (for example, basic dye-type chelates and acid dye-type chelates), nitro pigments, nitroso pigments, and aniline black, and also include carbon black prepared by a known method, such as a contact method, a furnace method, or a thermal method.

Specific examples of the pigment can be exemplified according to a desired type (color) of ink composition. Examples of the pigment for a yellow ink composition include C.I. pigment yellows 1, 2, 3, 12, 14, 16, 17, 73, 74, 75, 83, 93, 95, 97, 98, 109, 110, 114, 128, 129, 138, 139, 147, 150, 151, 154, 155, 180, and 185, and one or more thereof are used. In particular, one or more selected from the group consisting of C.I. pigment yellows 74, 110, 128, and 129 are preferably used. Examples of the pigment for a magenta ink composition include C.I. pigment reds 5, 7, 12, 48(Ca), 48(Mn), 57(Ca), 57:1, 112, 122, 123, 168, 184, 202, and 209 and C.I. pigment violet 19, and one or more thereof are used. In particular, one or more selected from the group consisting of C.I. pigment reds 122, 202, and 209 and C.I. pigment violet 19 are preferably used, and also a solid solution thereof may be used. Examples of the pigment for a cyan ink composition include C.I. pigment blues 1, 2, 3, 15:2, 15:3, 15:4, 15:34, 16, 22, and 60 and C.I. vat blues 4 and 60, and one or more thereof are used. In particular, C.I. pigment blue 15:3 and/or 15:4 are preferably used. In particular, C.I. pigment blue 15:3 is preferably used.

Examples of the pigment for a black ink composition include inorganic pigments, for example, carbons, such as lamp black (C.I. pigment black 6), acetylene black, furnace black (C.I. pigment black 7), channel black (C.I. pigment black 7), and carbon black (C.I. pigment black 7), and iron oxide pigments; and organic pigments, such as aniline black (C.I. pigment black 1). In an aspect of the invention, carbon black is preferably used. Examples of the carbon black include #2650, #2600, #2300, #2200, #1000, #980, #970, #966, #960, #950, #900, #850, MCF-88, #55, #52, #47, #45, #45L, #44, #33, #32, and #30 (products of Mitsubishi Chemical Corp.), Special Blaek 4A and 550 and Printex 95, 90, 85, 80, 75, 45, and 40 (products of Degussa AG), Regal 660, Rmogul L, and monarch 1400, 1300, 1100, 800, and 900 (products of Cabot Corp.), and Raven 7000, 5750, 5250, 3500, 2500 ULTRA, 2000, 1500, 1255, 1200, 1190 ULTRA, 1170, 1100 ULTRA, and Raven 5000 UIII (products of Columbian Chemicals Co.).

The concentration of the pigment may be adjusted to an appropriate concentration (content) when the ink composition is prepared and is not particularly limited. However, in an aspect of the invention, the concentration of the solid of the pigment is preferably 1.0 to 10.0% by mass, and an amount of 1.0 to 3.0% by mass is preferred from the viewpoint of graininess. Ink droplets wet and spread on the surface of a recording medium when they adhere onto the recording medium. Since the fluidity of the ink is rapidly lost after stoppage of the saturation and spreading by adjusting a solid concentration of the pigment to a high level of 1.0% by mass or more, bleeding can be further inhibited even when low-resolution printing is performed on a recording medium, such as printing paper. That is, it is assumed that the use of a combination of the poor water-soluble alkanediol, the crystalline sugar alcohol, and one or more selected from the group consisting of the polyalkylene glycols and the water-soluble both-end-type alkanediols allows the ink to wet and spread even on a recording medium having low ink absorbability; the crystalline sugar alcohol acts so as to increase the amount of solid matter for accelerating drying rate without significantly increasing the initial viscosity; and the increased amount of solid matter due to the pigment in the ink decreases the fluidity of the ink on a recording medium to inhibit bleeding. In particular, the effects of inhibiting beading and bleeding are significant when the recording time interval from landing of an ink droplet until the next ink droplet lands so as to be adjacent or overlap the previous ink droplet is about 0.1 second or more and shorter than 2 seconds. The term “recording time interval” refers to the interval of time from application of a plurality of different inks onto a recording medium until the inks land so as to be adjacent or overlap to each other or the interval of time between two sequential recordings when recording is separately performed until recording resolution is obtained.

The above-mentioned pigment is preferably kneaded with a dispersant described below, from the viewpoints of achieving good balance among gloss of an image, prevention of bronzing, and storage stability of the ink composition and also of forming the color image with more excellent gloss.

### Inorganic Pigment

The ink composition according to an aspect of the invention preferably contains an inorganic pigment shown below, in addition to the above-mentioned colorant, from the viewpoints of prevention of bleeding and beading, adjustment of initial viscosity, and ability of adjusting the change in viscosity after storage. Examples of the inorganic pigment in the above-mentioned viewpoints includes white pigments, such as kaoline, clay, talc, calcium carbonate, silica, titanium oxide, iron oxide, zirconium oxide, zinc oxide, barium sulfate, and alumina, and sedimentary or sintered matters thereof. According to a preferred aspect of the invention, an ink composition containing one or two selected from the group consisting of titanium dioxide and zirconium dioxide as the organic pigment is provided.

The average primary particle size of the white pigment is preferably 400 nm or less from the viewpoint of achieving both effects of white color formation and sedimentation prevention, more preferably 200 nm or less from the viewpoints of effects of enhancing gloss of a printed matter and inhibiting a bronzing phenomenon, and most preferably 120 nm or less from the viewpoints of effects of reducing viscosity of ink and inhibiting sedimentation of the white pigment. Here, the term “primary particle size” refers to the size of a particle formed by aggregation of monocrystals or crystallites similar thereto. The primary particle size of a pigment may be measured by electron microscopy. In the electron microscopy, the size of a pigment particle is measured from an electron microscopic photogram, and the reliability of the value can be further increased by image processing and measuring from a transmission electron microscopic photogram obtained by dispersing the pigment in an organic solvent and fixing it on a supporting film. Specifically, the minor axis diameter and the major axis diameter of each primary particle are measured; the diameter of a circle having the same area of the primary particle is arithmetically determined as the primary particle size; and the average value of the primary particle sizes of 50 or more pigment particles randomly selected from a predetermined view is determined. Though another measurement method that can achieve similar reliability may be used, when there is a substantial difference in numerical values, the value determined by the above-described method is employed.

### Dispersant

The ink composition according to an aspect of the invention preferably contains, as a dispersant for dispersing the colorant, at least one resin selected from the group consisting of styrene-acrylic acid-based copolymer resins, oxyethyl acrylate-based resins, urethane-based resins, and fluorene-based resins, and more preferably at least one selected from the group consisting of oxyethyl acrylate-based resins and fluorene-based resins. These copolymer resins improve the dispersing property by being adsorbed to the pigment.

Examples of the hydrophobic monomer of the copolymer resin include methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, sec-butyl acrylate, sec-butyl methacrylate, tert-butyl acrylate, tert-butyl methacrylate, n-hexyl acrylate, n-hexyl methacrylate, n-octyl acrylate, n-octyl methacrylate, iso-octyl acrylate, iso-octyl methacrylate, 2-ethyl hexyl acrylate, 2-ethyl hexyl methacrylate, decyl acrylate, decyl methacrylate, lauryl acrylate, lauryl methacrylate, stearyl acrylate, stearyl methacrylate, 2-hydroxyethyl acrylate, 2-hydroxyethyl methacrylate, 2-hydroxypropyl acrylate, 2-hydroxypropyl methacrylate, 2-dimethylaminoethyl acrylate, 2-dimethylaminoethyl methacrylate, 2-diethylaminoethyl acrylate, 2-diethylaminoethyl methacrylate, glycidyl acrylate, glycidyl methacrylate, allyl acrylate, allyl methacrylate, cyclohexyl acrylate, cyclohexyl methacrylate, phenyl acrylate, phenyl methacrylate, nonylphenyl acrylate, nonylphenyl methacrylate, benzyl acrylate, benzyl methacrylate, dicyclopentenyl acrylate, dicyclopentenyl methacrylate, bornyl acrylate, bornyl methacrylate, 1,3-butanediol diacrylate, 1,3-butanediol dimethacrylate, 1,4-butanediol diacrylate, 1,4-butanediol dimethacrylate, ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, polyethylene glycol diacrylate, polyethylene glycol dimethacrylate, neopentyl glycol diacrylate, 1,6-hexanediol diacrylate, 1,6-hexanediol dimethacrylate, dipropylene glycol diacrylate, dipropylene glycol dimethacrylate, trimethylol propane triacrylate, trimethylol propane trimethacrylate, glycerol acrylate, glycerol methacrylate, styrene, methylstyrene, vinyl toluene, and hydroxyethylated orthophenylphenol acrylate. These may be used alone or as a mixture of two or more thereof.

Examples of the hydrophilic monomer include acrylic acid, methacrylic acid, maleic acid, and itaconic acid.

From the viewpoints of achieving good balance among gloss of a color image, preventing bronzing, and enhancing storage stability of the ink composition and also of forming the color image with more excellent gloss, the copolymer resin of the above-mentioned hydrophobic monomer and hydrophilic monomer is preferably at least any of a styrene-(meth)acrylic acid copolymer resin, a styrene-methylstyrene-(meth)acrylic acid copolymer resin, a styrene-maleic acid copolymer resin, a (meth)acrylic acid-(meth)acrylic acid ester copolymer resin, a styrene-(meth)acrylic acid-(meth)acrylic acid ester copolymer resin, and a hydroxyethylated orthophenylphenol acrylic acid ester-(meth)acrylic acid copolymer resin.

The copolymer resin may be a resin containing a polymer prepared by a reaction of styrene and acrylic acid or acrylic acid ester (styrene-acrylic acid resin). Alternatively, the copolymer resin may be an acrylic acid-based water-soluble resin or a salt thereof, such as a sodium, potassium, ammonium, triethanolamine, triisopropanolamine, triethylamine, or diethanolamine salt.

The acid value of the copolymer resin is preferably 50 to 320 and more preferably 100 to 250 from the viewpoints of achieving good balance among gloss of a color image, prevention of bronzing, and storage stability of the ink composition and also of forming the color image with more excellent gloss.

The weight-average molecular weight (Mw) of the copolymer resin is preferably 2000 to 30000 and more preferably 2000 to 20000 from the viewpoints of achieving good balance among gloss of a color image, prevention of bronzing, and storage stability of the ink composition and also of forming the color image with more excellent gloss.

The glass transition temperature (Tg: measured in accordance with JIS K6900) of the copolymer resin is preferably 30° C. or more and more preferably 50 to 130° C. from the viewpoints of achieving good balance among gloss of a color image, prevention of bronzing, and storage stability of the ink composition and also of forming the color image with more excellent gloss.

The copolymer resin is adsorbed to the pigment or is free in a pigment dispersion and preferably has a maximum particle diameter of 0.3 μm or less and more preferably has an average particle diameter of 0.2 μm or less (more preferably 0.1 μm or less), from the viewpoints of achieving good balance among gloss of a color image, prevention of bronzing, and storage stability of the ink composition and also of forming the color image with more excellent gloss. Here, the average particle diameter is the average value of dispersion diameters (50% cumulative diameter) of particles actually formed by the pigment in a dispersion and can be measured with, for example, Microtrac UPA (Microtrac Inc.).

The content of the copolymer resin is preferably 20 to 50 parts by mass and more preferably 20 to 40 parts by mass based on 100 parts by mass of the pigment, from the viewpoints of achieving good balance among gloss of a color image, prevention of bronzing, and storage stability of the ink composition and also of forming the color image with more excellent gloss.

In an aspect of the invention, oxyethyl acrylate-based resins also can be used as the copolymer resin. The use of such a resin provides a reduction in the initial viscosity of ink, excellent storage stability at high temperature, and an excellent recovery property from clogging and is therefore more preferred.

The oxyethyl acrylate-based resin is not particularly limited as long as it has an oxyethyl acrylate skeleton, but is preferably a compound represented by the following Formula (I). Examples of the compound represented by Formula (I) include resins containing, in molar proportions of monomers, 45 to 55% of ortho-hydroxyethylated phenylphenol acrylate having CAS No. 72009-86-0, 20 to 30% of acrylic acid having CAS No. 79-10-7, and 20 to 30% of methacrylic acid having CAS No. 79-41-4. These may be used alone or as a mixture of two or more thereof. Furthermore, the monomer composition ratios are not particularly limited, but are preferably 70 to 85% by mass of the ortho-hydroxyethylated phenylphenol acrylate having CAS No. 72009-86-0, 5 to 15% by mass of acrylic acid having CAS No. 79-10-7, and 10 to 20% by mass of methacrylic acid having CAS No. 79-41-4.

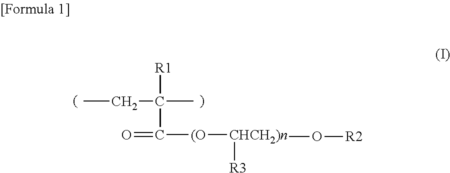

(R1 and/or R3 are a hydrogen atom or a methyl group, R2 is an alkyl group or an aryl group, and n is an integer of 1 or more.)

Preferred examples of the compound represented by Formula (I) include nonylphenoxypolyethylene glycol acrylate and polypropylene glycol #700 acrylate.

The content of the oxyethyl acrylate-based resin is preferably 10 to 40 parts by mass and more preferably 15 to 25 parts by mass based on 100 parts by mass of the pigment, from the viewpoints of achieving good balance between the initial viscosity of the ink composition and storage stability of the ink composition and also of preventing aggregation spots and forming a color image having an excellent burying property.

The total composition ratio of the resins derived from monomers having hydroxyl groups selected from the group consisting of acrylic acids and methacrylic acids in the oxyethyl acrylate-based resin is preferably 30 to 70% and more preferably 40 to 60%, from the viewpoints of achieving good balance between the initial viscosity of the ink composition and the storage stability of the ink composition and also of the recovery property from clogging.

The number-average molecular weight (Mn) of the oxyethyl acrylate-based resin before cross-linking is preferably 4000 to 9000 and more preferably 5000 to 8000, from the viewpoints of achieving good balance between the initial viscosity of the ink composition and the storage stability of the ink composition. The Mn is measured by, for example, gel permeation chromatography (GPC).

The oxyethyl acrylate-based resin is adsorbed to the pigment or is free in a pigment dispersion, and the copolymer resin preferably has a maximum particle diameter of 0.3 μm or less and more preferably has an average particle diameter of 0.2 μm or less (more preferably 0.1 μm or less), from the viewpoints of achieving good balance among gloss of a color image, prevention of bronzing, and storage stability of the ink composition and also of forming the color image with more excellent gloss. Here, the average particle diameter is the average value of dispersion diameters (50% cumulative diameter) of particles actually formed by the pigment in a dispersion and can be measured with, for example, Microtrac UPA (Microtrac Inc.).

The content of the oxyethyl acrylate-based resin is preferably 20 to 50 parts by mass and more preferably 20 to 40 parts by mass based on 100 parts by mass of the pigment, from the viewpoints of achieving good balance among gloss of a color image, prevention of bronzing, and storage stability of the ink composition and also of forming the color image with more excellent gloss.

Furthermore, in an aspect of the invention, by using a urethane-based resin as a fixative pigment dispersant, good balance among gloss of a color image, prevention of bronzing, and storage stability of the ink composition can be achieved, and the color image having more excellent gloss can be formed. The urethane-based resin is a resin containing a polymer obtained by a reaction of a diisocyanate compound and a diol compound and is preferably a resin having a urethane bond and/or an amide bond and an acid group, in an aspect of the invention.

Examples of the diisocyanate compound include araliphatic diisocyanate compounds such as hexamethylene diisocyanate and 2,2,4-trimethyl hexamethylene diisocyanate; aromatic diisocyanate compounds such as toluylene diisocyanate and phenylmethane diisocyanate; and modified derivatives thereof.

Examples of the diol compound include polyethers such as polyethylene glycol and polypropylene glycol; polyesters such as polyethylene adipate and polybutylene adipate; and polycarbonates.

The acid value of the urethane-based resin is preferably 10 to 300 and more preferably 20 to 100 from the viewpoints of achieving good balance among gloss of a color image, prevention of bronzing, and storage stability of the ink composition and also of forming the color image with more excellent gloss. Here, the acid value is the number of mg of KOH required to neutralize 1 g of the resin.

The weight-average molecular weight (Mw) of the urethane resin before cross-linking is preferably 100 to 200000 and more preferably 1000 to 50000 from the viewpoints of achieving good balance among gloss of a color image, prevention of bronzing, and storage stability of the ink composition and also of forming the color image with more excellent gloss. The Mw is measured by, for example, gel permeation chromatography (GPC).

The glass transition temperature (Tg: measured in accordance with JIS K6900) of the urethane resin is preferably −50 to 200° C. and more preferably −50 to 100° C. from the viewpoints of achieving good balance among gloss of a color image, prevention of bronzing, and storage stability of the ink composition and also of forming the color image with more excellent gloss.

The urethane-based resin preferably has a carboxyl group.

The content of the urethane-based resin is preferably 20 to 50 parts by mass and more preferably 20 to 40 parts by mass based on 100 parts by mass of the pigment from the viewpoints of achieving good balance among gloss of a color image, prevention of bronzing, and storage stability of the ink composition and also of forming the color image with more excellent gloss.

Furthermore, in an aspect of the invention, a fluorene-based resin can be used as a fixative pigment dispersant. The use such a resin causes a reduction in the initial viscosity of ink and provides excellent storage stability at high temperature and an excellent fixing property to printing paper, and is therefore preferred.

In addition, the fluorene-based resin is not particularly limited as long as it has a fluorene skeleton, and, for example, can be obtained by copolymerizing the following monomer units:

cyclohexane, 5-isocyanate-1-(isocyanate methyl)-1,3,3-trimethyl (CAS No. 4098-71-9);

ethanol, 2,2′-[9H-fluoren-9-ylidenebis(4,1-phenyleneoxy)]bis (CAS No. 117344-32-8);

propionic acid, 3-hydroxy-2-(hydroxymethyl)-2-methyl (CAS No. 4767-03-7); and

ethanamine, N,N-diethyl- (CAS No. 121-44-8).

The monomer composition ratio of the fluorene resin is not particularly limited as long as the resin has a fluorene skeleton, but is preferably 35 to 45% by mass of cyclohexane, 5-isocyanate-1-(isocyanate methyl)-1,3,3-trimethyl (CAS No. 4098-71-9), 40 to 60% by mass of ethanol, 2,2′-[9H-fluoren-9-ylidenebis(4,1-phenyleneoxy)]bis (CAS No. 117344-32-8), 5 to 15% by mass of propionic acid, 3-hydroxy-2-(hydroxymethyl)-2-methyl (CAS No. 4767-03-7), and 5 to 15% by mass of ethanamine, N,N-diethyl- (CAS No. 121-44-8).

The number-average molecular weight (Mn) of the fluorene-based resin before cross-linking is preferably 2000 to 5000 and more preferably 3000 to 4000 from the viewpoints of achieving good balance between the initial viscosity of the ink composition and the storage stability of the ink composition. The Mn is measured by, for example, gel permeation chromatography (GPC).

The fluorene-based resin is adsorbed to the pigment or is free in a pigment dispersion, and the copolymer resin preferably has a maximum particle diameter of 0.3 μm or less and more preferably has an average particle diameter of 0.2 μm or less (further preferably 0.1 μm or less), from the viewpoints of achieving good balance among gloss of a color image, prevention of bronzing, and storage stability of the ink composition and also of forming the color image with more excellent gloss. Here, the average particle diameter is the average value of dispersion diameters of particles actually formed by the pigment in a dispersion (50% cumulative diameter) and can be measured with, for example, Microtrac UPA (Microtrac Inc.).

The content of the fluorene-based resin is preferably 20 to 50 parts by mass and more preferably 20 to 40 parts by mass based on 100 parts by mass of the pigment from the viewpoints of achieving good balance among a color image-fixing property, prevention of bronzing, and storage stability of the ink composition and also of forming the color image with a more excellent fixing property.

The mass ratio of the copolymer resin and the fixative pigment dispersant (the former/the latter) is preferably 1/2 to 2/1 and is more preferably 1/1.5 to 1.5/1 from the viewpoints of achieving good balance among gloss of a color image, prevention of bronzing, and storage stability of the ink composition and also of forming the color image with more excellent gloss.

The mass ratio of the solid content of the pigment and the total solid content of the copolymer resin and the fixative pigment dispersant (the former/the latter) is preferably 100/40 to 100/100 from the viewpoints of achieving good balance among gloss of a color image, prevention of bronzing, and storage stability of the ink composition and also of forming the color image with more excellent gloss.

Furthermore, a surfactant may be used as the dispersant. Examples of the surfactant include anionic surfactants, such as fatty acid salts, higher alkyl dicarboxylates, higher alcohol sulfates, higher alkyl sulfonates, condensation products of higher fatty acids and amino acids, sulfosuccinates, naphthenates, liquid fatty oil sulfates, and alkylallyl sulfonates; cationic surfactants, such as fatty acid amine salts, quaternary ammonium salts, sulfonium salts, and phosphonium; and nonionic surfactants, such as polyoxyethylene alkyl ethers, polyoxyethylene alkyl esters, sorbitan alkyl esters, and polyoxyethylene sorbitan alkyl esters. It is needless to say that these surfactants also function as surfactants when they are added to ink compositions.

### Surfactant

The ink composition for ink jet recording according to an aspect of the invention may contain a surfactant. By using the surfactant, an image having excellent gloss can be formed on a recording medium having a surface coated by a resin for receiving ink and also on a recording medium of which gloss is highly important, such as photographic paper. Especially, even when a recording medium having an application layer for receiving oil-based ink as the receiving layer of the surface, such as printing paper, is used, bleeding between colors can be prevented, and also whitening caused by reflected light, which occurs with an increase in the amount of adhering ink, can be prevented.

The surfactant used in an aspect of the invention is preferably a polyorganosiloxane-based surfactant, which can increase the permeability of ink by enhancing wettability to a recording medium surface, when a recording image is formed. When the polyorganosiloxane-based surfactant is used, since one type of the above-described poor water-soluble alkanediol and one type of the polyalkylene glycol are contained, the solubility of the surfactant in the ink is increased to prevent occurrence of insoluble matters or the like, and thereby an ink composition excellent in discharge stability can be provided.

The polyorganosiloxane-based surfactant is not particularly limited, but is preferably one that provides an aqueous solution having a dynamic surface tension of 26 mN/m or less at 1 Hz when the aqueous solution contains 20% by mass of glycerin, 10% by mass of 1,2-hexanediol, 0.1% by mass of the polyorganosiloxane-based surfactant, and 69.9% by mass of water. The dynamic surface tension can be measured with, for example, a bubble pressure dynamic surface tensiometer, BP-2 (Kruss GmbH).

As the surfactant described above, those that are commercially available may be used. For example, Olfine PD-501 (Nissin Chemical Industry Co., Ltd.), Olfine PD-570 (Nissin Chemical Industry Co., Ltd.), BYK-347 (BYK-Chemie), or BYK-348 (BYK-Chemie) can be used.

Furthermore, the polyorganosiloxane-based surfactant more preferably contains one or more compounds represented by the following Formula (II):

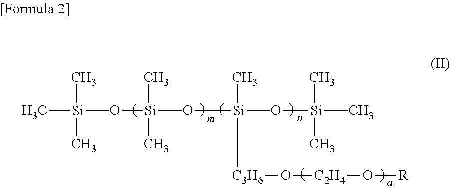

(in the formula, R represents a hydrogen atom or a methyl group, a represents an integer of 7 to 11, m represents an integer of 30 to 50, and n represents an integer of 3 to 5), or contains one or more compounds represented by Formula (II), wherein R represents a hydrogen atom or a methyl group, a represents an integer of 9 to 13, m represents an integer of 2 to 4, and n represents an integer of 1 or 2. Furthermore, the polyorganosiloxane-based surfactant more preferably contains one or more compounds represented by Formula (II), wherein R represents a hydrogen atom or a methyl group, a represents an integer of 6 to 18, m is 0, and n is 1; and more preferably contains one or more compounds represented by Formula (II), wherein R represents a hydrogen atom, a represents an integer of 2 to 5, m represents an integer of 20 to 40, and n represents an integer of 3 to 5. The use of such a specific polyorganosiloxane-based surfactant further reduces beading and bleeding of ink even in printing using printing paper as the recording medium.

Beading of ink can be further reduced by using a compound represented by Formula (II) wherein R is a methyl group, and bleeding of ink can be also reduced by simultaneously using a compound represented by Formula (II) wherein R is a hydrogen atom.

By appropriately adjusting the ratio of a compound represented by Formula (II) wherein R is a methyl group and a compound represented by Formula (II) wherein R is a hydrogen atom, a high-quality image free from bleeding and beading can be realized. In addition, the compounds are effective as adjusters when fluidity varies depending on the type of a pigment and the amount of a resin.

The amount of the surfactant contained in the ink composition according to an aspect of the invention is preferably 0.01 to 1.0% by mass and more preferably 0.05 to 0.50% by mass. In particular, when the surfactant is a compound in which R is a hydrogen atom, the amount thereof is preferably smaller than that when the surfactant is a compound in which R is a methyl group, from the viewpoint of beading. When a compound in which R is a hydrogen atom is used as the surfactant in an amount of 0.01 to 0.1% by mass, water repellency is provided, and bleeding can be prevented.

In addition, a Gemini-type surfactant can be suitably used as the surfactant used in an aspect of the invention. Use of the Gemini-type surfactant in combination with the poor water-soluble alkanediol can uniformly disperse the poor water-soluble solvent, resulting in a reduction in the initial viscosity of ink. Therefore, the amounts of the color material, the clogging-preventing agent, and other additives contained in the ink composition can be increased, and, as a result, an image having excellent color producibility can be formed not only on plain paper but also on a recording medium having a porous surface on which a resin or particles for receiving ink is coated. Especially, even when a recording medium having an application layer for receiving oil-based ink as the receiving layer of the surface, such as printing paper, is used, bleeding between colors can be prevented, and also color density spots caused by ink flow among dots, which occurs with an increase in the amount of adhering ink, can be prevented. The reason thereof is not clear, but it is thought that the fluidity of the colorant is lost because that the Gemini-type surfactant forms extremely stable oil gel with the poor water-soluble solvent due to the excellent orientation of the Gemini-type surfactant. Therefore, the addition of the Gemini-type surfactant is more effective when the amount of the poor water-soluble solvent is larger. Here, the term “Gemini-type surfactant” refers to a surfactant having a structure in which two surfactant molecules are connected to each other via a linker.

The Gemini-type surfactant is preferably a two-chain/three-hydrophilic group-type surfactant having a structure in which the hydrophilic group portions of a couple of one-chain type surfactants are connected to each other via a linker having a hydrophilic group. Furthermore, the hydrophilic group portions of the one-chain-type surfactants are preferably acidic amino acid residues, and the linker is preferably a basic amino acid. A specific example is a surfactant having a structure in which a couple of one-chain-type surfactants having glutamic acid or aspartic acid as the hydrophilic group portions are connected to each other via a linker such as arginine, lysine, or histidine. The Gemini-type surfactant used in an aspect of the invention is preferably a surfactant represented by the following Formula (III):

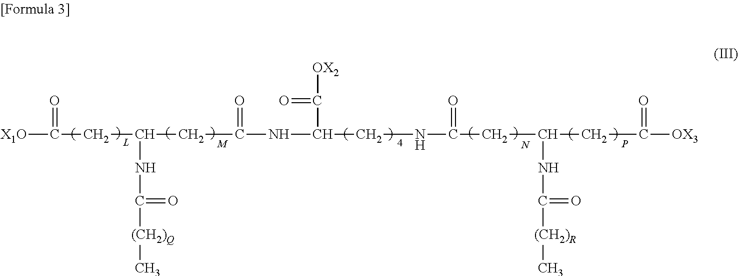

(in the Formula, X₁, X₂, and X₃ each independently represent a hydrogen atom or an alkali metal, but do not simultaneously represent hydrogen atoms or alkali metals; L and M each independently represent 0 or 2, but do not simultaneously represent 0 or 2; N and P each independently represent 0 or 2, but do not simultaneously represent 0 or 2; Q and R each represent an integer of 8 to 18).

In Formula (III), the alkali metal is preferably Na, and Q and R are each preferably around 10. Examples of such compounds include sodium salts of condensation products of N-lauroyl-L-glutamic acid and L-lysine. The compounds represented by Formula (III) may be those that are commercially available. For example, Pellicer L-30 (a product of Asahi Kasei Chemicals Corp.), which is an aqueous solution containing 30% of a sodium salt of a condensation product of N-lauroyl-L-glutamic acid and L-lysine, can be suitably used.

In an aspect of the invention, by using the Gemini-type surfactant, wettability to a recording medium surface is enhanced to increase the permeability of ink when a recording image is formed. As a result, uneven aggregation of ink is reduced even when printing is performed using printing paper as a recording medium. In addition, since the ink composition according to an aspect of the invention contains the poor water-soluble alkanediol, the solubility of the surfactant in ink is improved to inhibit generation of insoluble matters or the like. Therefore, an ink composition having more excellent discharge stability can be achieved.

The amount of the Gemini-type surfactant contained in the ink composition according to an aspect of the invention is preferably 0.01 to 1.0% by mass and more preferably 0.05 to 0.50% by mass.

The ink composition according to a preferred aspect of the invention can contain both the polyorganosiloxane-based surfactant and the Gemini-type surfactant. The ink composition according to an aspect of the invention containing both these two types of surfactants can realize a high-quality image free from bleeding and beading, and also these surfactants are effective as adjusters when fluidity varies depending on the type of a pigment or the amount of a resin.

The ink composition according to an aspect of the invention may further contain another surfactant, for example, an acetylene glycol-based surfactant, an anionic surfactant, a nonionic surfactant, or an ampholytic surfactant.

Among them, examples of the acetylene glycol-based surfactant include 2,4,7,9-tetramethyl-5-decyne-4,7-diol, 3,6-dimethyl-4-octyne-3,6-diol, 3,5-dimethyl-1-hexyn-3-ol, and 2,4-dimethyl-5-hexyn-3-ol. The acetylene glycol-based surfactant may be those that are commercially available, and examples thereof include Olfin E1010, STG, and Y (trade names of Nissin Chemical Industry Co., Ltd.), Surfynol 61, 104, 82, 465, 485, and TG (trade names of Air Products and Chemicals Inc.).

### Water and Other Components

The ink composition for ink jet recording according to an aspect of the invention contains water as a solvent, in addition to the above-described specific poor water-soluble alkanediol, the specific polyalkylene glycol, the surfactant, and other various additives. The water is preferably pure water or ultrapure water, such as ion-exchange water, ultrafiltered water, reverse osmosis water, or distilled water. In particular, pure or ultrapure water subjected to sterilization with ultraviolet irradiation or addition of hydrogen peroxide can prevent occurrence of mold and bacteria over a long period of time and is therefore preferred.

Furthermore, the ink composition according to an aspect of the invention preferably contains a penetrant, in addition to the above-mentioned components.

As the penetrant, glycol ethers can be suitably used.

Examples of the glycol ethers include ethylene glycol monomethyl ether, ethylene glycol monoethyl ether, ethylene glycol mono-iso-propyl ether, ethylene glycol mono-n-butyl ether, ethylene glycol mono-iso-butyl ether, ethylene glycol mono-tert-butyl ether, ethylene glycol monomethyl ether acetate, diethylene glycol monomethyl ether, diethylene glycol monoethyl ether, diethylene glycol mono-n-propyl ether, diethylene glycol mono-iso-propyl ether, diethylene glycol mono-n-butyl ether, diethylene glycol mono-tert-butyl ether, triethylene glycol mono-n-butyl ether, propylene glycol monomethyl ether, propylene glycol monoethyl ether, propylene glycol mono-n-propyl ether, propylene glycol mono-iso-propyl ether, propylene glycol mono-n-butyl ether, propylene glycol mono-tert-butyl ether, dipropylene glycol monomethyl ether, dipropylene glycol monoethyl ether, dipropylene glycol mono-n-propyl ether, dipropylene glycol iso-propyl ether, dipropylene glycol mono-n-butyl ether, dipropylene glycol mono-tert-butyl ether, and 1-methyl-1-methoxybutanol. These may be used alone or as a mixture of two or more thereof.

Among the above-mentioned glycol ethers, preferred are alkyl ethers of polyols, and particularly preferred are ethylene glycol monoethyl ether, ethylene glycol mono-n-butyl ether, diethylene glycol monomethyl ether, diethylene glycol monoethyl ether, diethylene glycol mono-n-butyl ether, propylene glycol monomethyl ether, propylene glycol monoethyl ether, propylene glycol monobutyl ether, triethylene glycol monomethyl ether, triethylene glycol monoethyl ether, and triethylene glycol mono-n-butyl ether.

More preferred are triethylene glycol monomethyl ether and triethylene glycol mono-n-butyl ether.

The amount of the penetrant may be appropriately determined, but is preferably about 0.1 to 30% by mass and more preferably about 1 to 20% by mass.

Furthermore, the ink composition according to an aspect of the invention preferably contains a recording medium-dissolving agent, in addition to the above-mentioned components.

As the recording medium-dissolving agent, pyrrolidones, such as N-methyl-2-pyrrolidone, pyrrolidone carbonate, and alkali metal salts thereof, can be suitably used. The amount of the recording medium-dissolving agent may be appropriately determined, but is preferably about 0.1 to 30% by mass and more preferably about 1 to 20% by mass.

The ink composition for ink jet recording according to an aspect of the invention preferably contains a wetting agent, for example, glycerin or its derivative such as 3-(2-hydroxyethoxy)-1,2-propanediol (CAS No. 14641-24-8) or 3-(2-hydroxypropoxy)-1,2-propanediol. Glycerin and its derivative can prevent ink, for example, in an ink jet nozzle from drying and solidifying and is therefore preferred from the viewpoint of a recovery property from clogging. In an aspect of the invention, the amount of the wetting agent is preferably 0.1 to 8% by mass or less.

The ink composition according to an aspect of the invention can further contain a nozzle clogging-preventing agent, an antiseptic, an antioxidant, an electroconductivity adjuster, a pH adjuster, a viscosity modifier, a surface tension adjuster, and an oxygen absorber, for example.

Examples of the antiseptic/anti-fungal agents include sodium benzoate, sodium pentachlorophenol, sodium 2-pyridinethiol-1-oxide, sodium sorbate, sodium dehydroacetate, and 1,2-dibenzine thiazolin-3-one (Proxel CRL, Proxel BND, Proxel GXL, Proxel XL-2, and Proxel TN, available from ICI Co., Ltd.).

Furthermore, examples of the pH adjuster, a solubilization aid, or the antioxidant include amines, such as diethanolamine, triethanolamine, propanolamine, and morpholine and modified products thereof; inorganic salts, such as potassium hydroxide, sodium hydroxide, and lithium hydroxide; ammonium hydroxide; quaternary ammonium hydroxide (for example, tetramethyl ammonium); carbonates, such as potassium carbonate, sodium carbonate, and lithium carbonate; phosphates; ureas, such as N-methyl-2-pyrrolidone, urea, thiourea, and tetramethylurea; allophanates, such as allophanate and methyl allophanate; biurets, such as biuret, dimethyl biuret, and tetramethyl biuret; and L-ascorbic acid and salts thereof.

In addition, the ink composition according to an aspect of the invention may contain an antioxidant and an ultraviolet absorber, and examples thereof include Tinuvin 328, 900, 1130, 384, 292, 123, 144, 622, 770, and 292, Irgacor 252 and 153, and Irganox 1010, 1076, 1035, and MD 1024 (Chiba Specialty Chemicals Inc.) and oxides of lanthanide.

The ink composition according to an aspect of the invention can be produced by dispersing and mixing each component described above by a proper method. Preferably, first, a uniform pigment dispersion is prepared by mixing a pigment, a polymer dispersant, and water with a proper disperser (for example, a ball mill, a sand mill, an attritor, a roll mill, an agitator mill, a Henschel mixer, a colloid mill, an ultrasonic homogenizer, a jet mill, or an angmill). Then, added to the resulting pigment dispersion are a separately prepared resin (resin emulsion), water, a water-soluble organic solvent, a saccharide, a pH adjuster, an antiseptic, an anti-fungal agent, and other components. They are sufficiently dissolving to prepare an ink solution. After sufficient stirring, coarse particles and foreign materials, which cause clogging, are removed by filtration to obtain a target ink composition. The filtration is preferably performed using a glass fiber filter. The glass fiber is preferably resin-impregnated glass fiber from the viewpoint of electrostatic adsorption ability. The pore size of the glass fiber filter is preferably 1 to 40 μm and more preferably 1 to 10 μm from the viewpoints of productivity and adsorptive removal of, for example, an electric charge-free resin. By sufficiently removing adsorption of an electric charge-free resin, etc., the discharge stability can be improved. An example of the filter is Ultipor GF Plus, a product of Nihon Pall Ltd. Ink jet recording method

An ink jet recording method according to an aspect of the invention performs printing by discharging droplets of the ink composition described above and letting the droplets adhere to a recording medium. In the recording method according to an aspect of the invention, it is preferable to use synthetic paper or printing paper (OKT+: a product of Oji Paper Co., Ltd.) as a recording medium. Especially, a high-quality image free from bleeding and beading can be realized on art paper, paper for high image quality used in print on demand (POD), and exclusive paper for laser printers, in particular, even in low-resolution printing. Examples of the paper for high image quality used in POD include Ricoh business coat gloss 100 (a product of Ricoh Company, Ltd.). Examples of the exclusive paper for laser printers include LPCCTA4 (a product of Seiko Epson Corp.). Examples of water resistant paper include Kareka (a product of Mitsubishi Kagaku Media Co., Ltd.) and LaserPeach (a product of Nisshinbo Postal Chemical Co., Ltd.).

### Ink Set

The ink set according to an aspect of the invention includes at least one or more selected from the group consisting of yellow ink compositions, magenta ink compositions, and cyan ink compositions. In a preferred ink set according to an aspect of the invention, since adjustment of the initial viscosity and the change in viscosity after storage are possible and the mass of discharged ink of each color can be stabilized for a long time, one or more selected from the group consisting of the yellow ink compositions, the magenta ink compositions, and the cyan ink compositions contain the above-described inorganic pigment.

### EXAMPLES

The invention will now be described further in detail below with reference to examples, but is not limited to those examples.

### Preparation of ink Composition

Inks having compositions shown in Table 1 were prepared by mixing each component and filtering the mixture through a membrane filter with a pore size of 10 μm. The numerical values shown in Table 1 represent contents (% by mass) in ink. The contents (% by mass) of resins are shown by their solid contents. Here, the oxyethylacrylate-based resin (oxyethyl resin) in Table 1 is a resin having a molecular weight of 6900 and containing a monomer having an oxyethyl acrylate structure shown by CAS No. 72009-86-0 in a monomer component ratio of about 75% by mass.

The fluorene-based resin (fluorene resin) is a resin having a molecular weight of 3300 and containing a monomer having a fluorene skeleton shown by CAS No. 117344-32-8 in a monomer component ratio of about 50% by mass.

In addition, the surfactant used is a polyorganosiloxane-based surfactant composed of a compound represented by Formula (II) wherein R is a methyl group, a is an integer of 6 to 18, m is 0, and n is 1, a compound represented by Formula (II) wherein R is a hydrogen atom, a is an integer of 7 to 11, m is an integer of 30 to 50, and n is an integer of 3 to 5, and a compound represented by Formula (II) wherein R is a methyl group, a is an integer of 9 to 13, m is an integer of 2 to 4, and n is an integer of 1 or 2. The surfactant provided an aqueous solution having a dynamic surface tension of not higher than 26 mN/m at 1 Hz when the aqueous solution was composed of 20% by mass of glycerin, 10% by mass of 1,2-hexanediol, 0.1% by mass of the surfactant, and 69.9% by mass of water. Specifically, the dynamic surface tension was measured at 1 Hz (one bubble/sec) with a bubble pressure dynamic surface tensiometer, BP-2 (Kruss GmbH), to confirm that the dynamic surface tension of the aqueous solution at 1 Hz was 24.6 mN/m. The tripropylene glycol was one manufactured by Asahi Glass Co., Ltd., and the trehalose was Treha powder manufactured by Hayashibara Shoji, Inc.

TABLE 1

| | Example 1 | Example 2 | Example 3 | Example 4 |
|---|---|---|---|---|
| 1,2-Octanediol | 2.0 | 2.0 | 2.0 | 2.0 |
| Tripropylene glycol | 2.0 | 4.0 | 2.0 | 4.0 |
| 3-Methyl-1,5-pentanediol | 4.0 | 2.0 | 4.0 | 2.0 |
| Trehalose | 12.0 | 12.0 | 24.0 | 24.0 |
| Glycerin | 5.0 | 5.0 | 5.0 | 5.0 |
| 1,2-Hexanediol | 1.0 | 1.0 | 1.0 | 1.0 |
| Surfactant | 0.2 | 0.2 | 0.2 | 0.2 |

| | | | | | |
|---|---|---|---|---|---|
| Dispersion | Oxyethyl resin | 0.4 | 0.4 | 0.4 | 0.4 |
| | Fluorene resin | 0.4 | 0.4 | 0.4 | 0.4 |
| | Pigment | 2.0 | 2.0 | 2.0 | 2.0 |
| | Ultrapure water | 15.4 | 15.4 | 15.4 | 15.4 |

| | | | | |
|---|---|---|---|---|
| Ultrapure water | 55.6 | 55.6 | 43.6 | 43.6 |
| Total | 100.0 | 100.0 | 100.0 | 100.0 |
| Recovery property from clogging | AA | AA | AA | AA |
| in high-temperature and low- | | | | |
| humidity open system | | | | |
| Recovery property from clogging | AA | AA | AA | AA |
| in high-temperature and ordinary- | | | | |
| humidity close system | | | | |
| Beading | A | A | A | A |
| Bleeding | A | AA | A | AA |
| Dot edge | A | A | A | A |
| Curling | B | B | A | A |
| Gloss | A | A | A | A |
| Bronzing | B | B | B | B |

| | | Example 5 | Example 6 | Example 7 | Example 8 | Example 9 | Example 10 |
|---|---|---|---|---|---|---|---|
| 1,2-Octanediol | | 2.0 | 2.0 | 2.0 | 2.0 | 2.0 | 2.0 |
| Tripropylene glycol | | 6.0 | 0.0 | 6.0 | 0.0 | 2.0 | 4.0 |
| 3-Methyl-1,5-pentanediol | | 0.0 | 6.0 | 0.0 | 6.0 | 4.0 | 2.0 |
| Trehalose | | 24.0 | 24.0 | 18.0 | 18.0 | 24.0 | 24.0 |
| Glycerin | | 5.0 | 5.0 | 5.0 | 5.0 | 5.0 | 5.0 |
| 1,2-Hexanediol | | 1.0 | 1.0 | 1.0 | 1.0 | 1.0 | 1.0 |
| Surfactant | | 0.2 | 0.2 | 0.2 | 0.2 | 0.2 | 0.2 |
| Dispersion | Oxyethyl resin | 0.4 | 0.4 | 1.4 | 1.4 | 0.4 | 0.4 |
| | Fluorene resin | 0.4 | 0.4 | 1.4 | 1.4 | 0.4 | 0.4 |
| | Pigment | 2.0 | 2.0 | 7.0 | 7.0 | 2.0 | 2.0 |
| | Ultrapure | 15.4 | 15.4 | 53.8 | 53.8 | 15.4 | 15.4 |
| | water | | | | | | |
| Dispersion | Oxyethyl resin | 0.0 | 0.0 | 0.0 | 0.0 | 1.0 | 1.0 |
| | Fluorene resin | 0.0 | 0.0 | 0.0 | 0.0 | 1.0 | 1.0 |
| | Pigment | 0.0 | 0.0 | 0.0 | 0.0 | 5.0 | 5.0 |
| | Ultrapure | 0.0 | 0.0 | 0.0 | 0.0 | 15.4 | 15.4 |
| | water | | | | | | |

| | | | | | | |
|---|---|---|---|---|---|---|
| Ultrapure water | 43.6 | 43.6 | 4.2 | 4.2 | 21.2 | 21.2 |
| Total | 100.0 | 100.0 | 100.0 | 100.0 | 100.0 | 100.0 |
| Recovery property from | AA | AA | AA | AA | AA | AA |
| clogging in high-temperature | | | | | | |
| and low-humidity open system | | | | | | |
| Recovery property from | AA | AA | AA | AA | AA | AA |
| clogging in high-temperature | | | | | | |
| and ordinary-humidity close | | | | | | |
| system | | | | | | |
| Beading | A | B | AA | A | A | A |
| Bleeding | A | AA | A | AA | AA | AA |
| Dot edge | B | AA | AA | AA | AA | AA |
| Curling | A | A | B | B | A | A |
| Gloss | A | A | B | B | B | B |
| Bronzing | B | B | B | B | A | A |

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| 1,2-Octanediol | | 2.0 | 2.0 | 2.0 | 2.0 | 2.0 | 2.0 |
| Tripropylene glycol | | 6.0 | 0.0 | 6.0 | 0.0 | 6.0 | 0.0 |
| 3-Methyl-1,5-pentanediol | | 0.0 | 6.0 | 0.0 | 6.0 | 0.0 | 6.0 |
| Trehalose | | 0.0 | 0.0 | 0.0 | 0.0 | 0.0 | 0.0 |
| Glycerin | | 5.0 | 5.0 | 29.0 | 29.0 | 5.0 | 5.0 |
| 1,2-Hexanediol | | 1.0 | 1.0 | 1.0 | 1.0 | 1.0 | 1.0 |
| Surfactant | | 0.2 | 0.2 | 0.2 | 0.2 | 0.2 | 0.2 |
| Dispersion | Oxyethyl resin | 0.4 | 0.4 | 0.4 | 0.4 | 1.4 | 1.4 |
| | Fluorene resin | 0.4 | 0.4 | 0.4 | 0.4 | 1.4 | 1.4 |
| | Pigment | 2.0 | 2.0 | 2.0 | 2.0 | 7.0 | 7.0 |
| | Ultrapure | 15.4 | 15.4 | 15.4 | 15.4 | 53.8 | 53.8 |
| | water | | | | | | |

| | | | | | | |
|---|---|---|---|---|---|---|
| Ultrapure water | 67.6 | 67.6 | 43.6 | 43.6 | 22.2 | 22.2 |
| Total | 100.0 | 100.0 | 100.0 | 100.0 | 100.0 | 100.0 |
| Recovery property from | B | B | B | B | B | B |
| clogging in high-temperature | | | | | | |
| and low-humidity open | | | | | | |
| system | | | | | | |
| Recovery property from | C | C | C | C | C | C |
| clogging in high-temperature | | | | | | |
| and ordinary-humidity close | | | | | | |
| system | | | | | | |
| Beading | C | C | C | C | B | C |
| Bleeding | C | C | C | C | A | A |
| Dot edge | A | A | B | B | A | AA |
| Curling | C | C | C | C | C | C |
| Gloss | A | A | A | A | B | B |
| Bronzing | B | B | B | B | B | B |

* In the following ink sets, “Y” contains C.I. pigment yellow 74 as a pigment, “M” contains C.I. pigment violet 19 as a pigment, “C” contains C.I. pigment blue 15:3 as a pigment, and “K” contains C.I. pigment black 7 as a pigment.

### Evaluation

Recovery Property from Clogging in High-Temperature and Low-Humidity Open System

An ink set including Y, M, C, and K inks prepared above was mounted on an ink cartridge of an ink jet printer (PXG930, a product of Seiko Epson Corp.) and set to the printer. Then, the head of the printer was filled with the ink using a printer driver to confirm that usual recording was possible. The carriage was transferred to the ink cartridge exchanging position, followed by unplugging. After dismounting of the ink cartridge from the printer, the head was detached. The head from which the ink cartridge and the head cap were removed was left to stand for three days under an environment of 50° C./15% humidity.

After the leaving, the head was set to the carriage again, and the ink cartridge, which was left to stand under an environment of ordinary temperature and ordinary humidity, was mounted on the printer. Then, cleaning operation was repeated until all nozzles discharged ink in an equal manner to that of the initial stage. The easiness of recovery was evaluated in accordance with the following criteria:

AA: recovered from clogging by repeating the cleaning operation six times;

A: recovered from clogging by repeating the cleaning operation twelve times;

B: recovered from clogging by repeating the cleaning operation sixteen times; and

C: not recovered from clogging by repeating the cleaning operation sixteen times.

The results are shown in Table 1.
Recovery Property from Clogging in High-Temperature and Ordinary-Humidity Close System

An ink set including Y, M, C, and K inks prepared above was mounted on an ink cartridge of an ink jet printer (PXG930, a product of Seiko Epson Corp.) and set to the printer. Then, the head of the printer was filled with the ink using a printer driver to confirm that usual recording was possible. Then, the energization was stopped by turning off the switches according to the usual usage procedure, followed by unplugging. The printer was left to stand for three days under an environment of 40° C./45% humidity.

After the leaving, the printer was energized, and cleaning operation was repeated until all nozzles discharged ink in an equal manner to that of the initial stage. The easiness of recovery was evaluated in accordance with the following criteria:

AA: recovered from clogging by repeating the cleaning operation six times;

A: recovered from clogging by repeating the cleaning operation twelve times;

B: recovered from clogging by repeating the cleaning operation sixteen times; and

C: not recovered from clogging by repeating the cleaning operation sixteen times.

The results are shown in Table 1. It was confirmed from Table 1 that the ink composition containing trehalose was excellent in recovery property from clogging in a high-temperature and ordinary-humidity close system.

### Evaluation of Image Quality: Ink Beading

An ink set including Y, M, C, and K inks prepared above was mounted on an ink cartridge of an ink jet printer (PX-F8000, a product of Seiko Epson Corp.) so as to perform recording at 360 dpi in the main scanning (head driving) direction and at 720 dpi in the sub-scanning (recording medium transporting) direction. Then, the voltage applied to a piezo element of the printer head was adjusted such that the dot weight at the time of landing was about 3 ng, and a solid image of 720×1440 dpi was recorded at 360×720 dpi per one driving on OKT+ having a paper weight of about 128 g/m² (manufactured by Oji Paper Co., Ltd.). The recording was conducted under an environment of ordinary temperature and ordinary humidity (25° C., 45% humidity). On this occasion, the amount of adhering ink of a monochromatic image at 100% duty was about 3.1 mg/inch².

The distance between the recording sheet and the recording head was 1 mm.

The recorded image was an image of a secondary color obtained by mixing monochromatic colors of the same duty.

The resulting images were evaluated in accordance with the following criteria:

AA: reproduced without beading up to a secondary color at 180% duty of each monochromatic color at 90% duty;

A: reproduced without beading up to a secondary color at 160% duty of each monochromatic color at 80% duty;

B: reproduced without beading up to a secondary color at 140% duty of each monochromatic color at 70% duty; and

C: reproduced without beading up to a secondary color at 120% duty of each monochromatic color at 60% duty.

The results are shown in Table 1.

### Evaluation of Image Quality: Ink Bleeding

An ink set including Y, M, C, and K inks prepared above was mounted on an ink cartridge of an ink jet printer (PX-F8000, a product of Seiko Epson Corp.) so as to perform recording at 360 dpi in the main scanning (head driving) direction and at 720 dpi in the sub-scanning (recording medium transporting) direction. Then, the voltage applied to a piezo element of the printer head was adjusted such that the dot weight at the time of landing was about 3 ng, and an image of 720×1440 dpi was recorded at 360×720 dpi per one driving on OKT+ having a paper weight of about 128 g/m² (manufactured by Oji Paper Co., Ltd.). The recording was conducted under an environment of ordinary temperature and ordinary humidity (25° C., 45% humidity). On this occasion, the amount of adhering ink of a monochromatic color at 100% duty was about 3.1 mg/inch².

The distance between the recording sheet and the recording head was 1 mm.

The recorded image was an image in which 2 to 8 pixel lines of a primary color at 80% duty were in contact with a secondary color at 160% duty of each color at 80% duty.

The resulting images were evaluated in accordance with the following criteria:

AA: reproduced 4/720 inch line without bleeding, but not reproduced 2/720 inch line due to bleeding;

A: reproduced 6/720 inch line without bleeding, but not reproduced 4/720 inch line due to bleeding;

B: reproduced 8/720 inch line without bleeding, but not reproduced 6/720 inch line due to bleeding; and

C: not reproduced 10/720 inch line due to bleeding.

The results are shown in Table 1.

### Evaluation of Dot Edge

An ink set including Y, M, C, and K inks prepared above was mounted on an ink cartridge of an ink jet printer (PX-F8000, a product of Seiko Epson Corp.) so as to perform recording at 360 dpi in the main scanning (head driving) direction and at 720 dpi in the sub-scanning (recording medium transporting) direction. Then, the voltage applied to a piezo element of the printer head was adjusted such that the dot weight at the time of landing was about 3 ng, and a fine-line image of 720×1 dpi was recorded at 360×720 dpi per one driving on OKT+ having a paper weight of about 128 g/m² (manufactured by Oji Paper Co., Ltd.). The recording was conducted under an environment of ordinary temperature and ordinary humidity (25° C., 45% humidity). On this occasion, the amount of adhering ink of a monochromatic color at 100% duty was about 3.1 mg/inch².

The distance between the recording sheet and the recording head was 1 mm.

The recorded images were monochromatic images.

The resulting images were evaluated in accordance with the following criteria:

AA: line having a width smaller than 70 μm and a width difference between the narrowest and the widest smaller than 14 μm;

A: line having a width not smaller than 70 μm and a width difference between the narrowest and the widest smaller than 14 μm; and

B: line having a width not smaller than 70 μm and a width difference between the narrowest and the widest not smaller than 14 μm.

The results are shown in Table 1.

### Evaluation of Curling

An ink set including Y, M, C, and K inks prepared above was mounted on an ink cartridge of an ink jet printer (PX-F8000, a product of Seiko Epson Corp.) so as to perform recording at 360 dpi in the main scanning (head driving) direction and at 720 dpi in the sub-scanning (recording medium transporting) direction. Then, the voltage applied to a piezo element of the printer head was adjusted such that the dot weight at the time of landing was about 3 ng, and a solid image of 720×720 dpi was recorded at 360×720 dpi per one driving on OKT+ having a paper weight of about 73.3 g/m² (manufactured by Oji Paper Co., Ltd.) and on Xerox P having a paper weight of about 60 g/m² (manufactured by Fuji Xerox Co., Ltd.), with a margin of about 6 mm on the periphery. The recording was conducted under an environment of ordinary temperature and ordinary humidity (25° C., 45% humidity). On this occasion, the amount of adhering ink of a monochromatic color at 100% duty was about 1.6 mg/inch². The resulting recorded matters were placed on a flat table with the recorded surfaces upward and were left to stand for three days under an environment of ordinary temperature and ordinary humidity (25° C., 45% humidity).

The recorded images were monochromatic images.

The resulting images were evaluated in accordance with the following criteria:

A: distance between the table and the rolled end of the paper is smaller than 10 mm;

B: distance between the table and the rolled end of the paper is from 10 mm to 20 mm; and

C: distance between the table and the rolled end of the paper is larger than 20 mm.

The results are shown in Table 1.

### Evaluation of Gloss

An ink set including Y, M, C, and K inks prepared above was mounted on an ink cartridge of an ink jet printer (PX-F8000, a product of Seiko Epson Corp.) so as to perform recording at 360 dpi in the main scanning (head driving) direction and at 360 dpi in the sub-scanning (recording medium transporting) direction. Then, the voltage applied to a piezo element of the printer head was adjusted such that the dot weight at the time of landing was about 7 ng, and a solid image (100% duty) of 1440×1440 dpi was recorded at 360×360 dpi per one driving on gloss photograph paper (manufactured by Seiko Epson Corp.). The recording was conducted under an environment of ordinary temperature and ordinary humidity (25° C., 45% humidity). On this occasion, the amount of adhering ink of a monochromatic color at 100% duty was about 14.5 mg/inch².

The distance between the recording sheet and the recording head was 1 mm. The recorded images were monochromatic images.

The degree of gloss of each resulting recorded matter was tested as follows. “GP-200”, a product of Murakami Color Research Laboratory Co., Ltd., was used with a halogen lamp (12 V, 50 W) as a light source and a ND-10 as a filter, and an evaluation object was irradiated with incident light passed through a slit with a width of 1 mm at an incident angle of 45 degrees at a sensitivity of 500 and a tilt angle of 0 degree. The voltage applied to the light source was adjusted so that the degree of gloss of a standard mirror plate at a reflection angle of 45 degrees was 42.5. The reflected light reflected by the evaluation object and passed through a slit having a width of 1.5 mm was measured in a reflection angle range of 42 to 48 degrees, and the maximum value of reflected light intensities measured as relative values was used as the degree of gloss. A greater maximum value of the degree of gloss means that the recorded matter has more excellent gloss.

The results were evaluated in accordance with the following criteria:

A: maximum degree of gloss is 40 or greater; and

B: maximum degree of gloss is 30 or greater and less than 40.

The evaluation results are shown in Table 1.

### Evaluation of Bronzing

An ink set including Y, M, C, and K inks prepared above was mounted on an ink cartridge of an ink jet printer (PX-F8000, a product of Seiko Epson Corp.) so as to perform recording at 360 dpi in the main scanning (head driving) direction and at 720 dpi in the sub-scanning (recording medium transporting) direction. Then, the voltage applied to a piezo element of the printer head was adjusted such that the dot weight at the time of landing was about 3 ng, and a solid image of 720×1440 dpi was recorded at 360×720 dpi per one driving on OKT+ having a paper weight of about 73.3 g/m² (manufactured by Oji Paper Co., Ltd.) with a margin of about 6 mm on the periphery. The recording was conducted under an environment of ordinary temperature and ordinary humidity (25° C., 45% humidity). On this occasion, the amount of adhering ink of a monochromatic color at 100% duty was about 3.1 mg/inch². The distance between the recording sheet and the recording head was 1 mm. The recorded images were monochromatic images.

The color of reflected light when the printed matter was irradiated with light from a white fluorescent lamp was observed.

The results were evaluated in accordance with the following criteria:

A: the color of light reflected by the printed matter irradiated with the white fluorescent lamp is white; and

B: the color of light reflected by the printed matter irradiated with the white fluorescent lamp is not white.

The evaluation results are shown in Table 1.

Ink compositions and ink sets of Examples 11 to 20 and Comparative Examples 7 to 12 were prepared as in Examples 1 to 10 and Comparative Examples 1 to 6, respectively, except that the surfactant was changed to Olfin E1010 (an alkylene oxide adduct of 2,4,7,9-tetramethyl-5-decyne-4,7-diol), an acetylene glycol-based surfactant manufactured by Nissin Chemical Industry Co., Ltd., or to Surfynol 104 (2,4,7,9-tetramethyl-5-decyne-4,7-diol), an acetylene glycol-based surfactant manufactured by Air Products and Chemicals Inc. (USA). Then, these ink compositions and ink sets were similarly evaluated to confirm that the evaluation results for beading and bleeding were all “C” and that other evaluation results were the same as those of Examples 11 to 20 and Comparative Examples 7 to 12, respectively.

The acetylene glycol-based surfactant provided an aqueous solution having a dynamic surface tension of not less than 27 mN/m at 1 Hz when the aqueous solution was composed of 20% by mass of glycerin, 10% by mass of 1,2-hexanediol, 0.1% by mass of the acetylene glycol-based surfactant, and 69.9% by mass of water. Specifically, the dynamic surface tension was measured at 1 Hz (one bubble/sec) with a bubble pressure dynamic surface tensiometer, BP-2 (Kruss GmbH), to confirm that the dynamic surface tension of the aqueous solution at 1 Hz was 27.8 mN/m.

Ink compositions and ink sets of Examples 21 to 24 and Comparative Examples 13 to 16 were prepared as in Examples 9, 10, 19, and 20 and Comparative Examples 5, 6, 11, and 12, respectively, except that the amount of glycerin was changed to 0% by mass and that the amount of ultrapure water was increased by the amount of glycerin. These ink compositions and ink sets were similarly evaluated to confirm that the levels of recovery property from clogging in the high-temperature and ordinary-humidity close system were decreased by one level and that other evaluation results were the same as those of Examples 9, 10, 19, and 20 and Comparative Examples 5, 6, 11, and 12, respectively.

What is claimed is:

1. An ink composition for ink jet recording comprising:
a colorant;
water;
a poor water-soluble alkanediol;
a crystalline sugar alcohol that is solid at 20° C.; and
one or two selected from the group consisting of polyalkylene glycols and water-soluble both-end-type alkanediols.

2. The ink composition according to claim 1, wherein the crystalline sugar alcohol is trehalose.

3. The ink composition according to claim 1, wherein the crystalline sugar alcohol is one or more selected from the group consisting of isotrehalose, neotrehalose, and sucrose.

4. The ink composition according to claim 1, further comprising a water-soluble one-end-type alkanediol.

5. The ink composition according to claim 1, wherein the water-soluble both-end-type alkanediols are one or more selected from the group consisting of 2-methyl-1,3-propanediol, 3-methyl-1,5-pentanediol, 1,5-pentanediol, and 1,6-hexanediol.

6. The ink composition according to claim 1, wherein the polyalkylene glycols are one or more selected from the group consisting of ethylene glycol, diethylene glycol, triethylene glycol, propylene glycol, dipropylene glycol, and tripropylene glycol.

7. The ink composition according to claim 1, wherein the polyalkylene glycols are polypropylene glycols.

8. The ink composition according to claim 7, wherein the polypropylene glycols are a diol type.

9. The ink composition according to claim 7, wherein the polypropylene glycols are tripropylene glycol.

10. The ink composition according to claim 1, wherein the content ratio of the poor water-soluble alkanediol and the crystalline sugar alcohol is 1:6 to 1:12.

11. The ink composition according to claim 1, wherein the sum of the content of the poor water-soluble alkanediol and the content of the crystalline sugar alcohol is 28.0% by mass or less based on the amount of the ink composition.

12. The ink composition according to claim 4, wherein the sum of the content of the water-soluble one-end-type alkanediol and the content of the crystalline sugar alcohol is 28.0% by mass or less based on the amount of the ink composition.

13. The ink composition according to claim 4, wherein the sum of the content of the crystalline sugar alcohol, the content of the water-soluble one-end-type alkanediol, and the content of the poor water-soluble alkanediol is 32.0% by mass or less based on the amount of the ink composition.

14. The ink composition according to claim 1, wherein the content of the polyalkylene glycol(s) is 2.0 to 6.0% by mass based on the amount of the ink composition.

15. The ink composition according to claim 1, wherein the content of the crystalline sugar alcohol is 12.0 to 24.0% by mass based on the amount of the ink composition.

16. The ink composition according to claim 1, wherein the poor water-soluble alkanediol is 1,2-octanediol.

17. The ink composition according to claim 1, further comprising an inorganic pigment.

18. The ink composition according to claim 1, further comprising a surfactant.

19. The ink composition according to claim 18, wherein the surfactant is a polyorganosiloxane-based surfactant or a Gemini-type surfactant.

20. The ink composition according to claim 19, wherein the polyorganosiloxane-based surfactant provides an aqueous solution having a dynamic surface tension of 26 mN/m or less at 1 Hz when the aqueous solution is composed of 20% by mass of glycerin, 10% by mass of 1,2-hexanediol, 0.1% by mass of the polyorganosiloxane-based surfactant, and 69.9% by mass of water.
